(19) United States
(12) Patent Application Publication
(10) Pub. No.: US 2026/0313290 A1
(43) Pub. Date: Oct. 8, 2026

(54) SOUND-INTEGRATED DISPLAY APPARATUS AND AN ELECTRONIC APPARATUS

(71) Applicant: POSTECH RESEARCH AND BUSINESS DEVELOPMENT FOUNDATION, Pohang-si (KR)

(72) Inventors: Su Seok CHOI, Pohang-si (KR); In Pyo HONG, Pohang-si (KR)

(73) Assignee: POSTECH RESEARCH AND BUSINESS DEVELOPMENT FOUNDATION, Pohang-si (KR)

(21) Appl. No.: 19/568,324

(22) Filed: Mar. 16, 2026

(30) Foreign Application Priority Data
Mar. 18, 2025 (KR) 10-2025-0034651
Mar. 5, 2026 (KR) 10-2026-0040022

(51) Int. Cl. H04R 1/28; H04R 1/26

(52) U.S. Cl. CPC H04R 1/2888; H04R 1/26; H04R 2499/15

(57) ABSTRACT

The present invention relates to a sound-integrated display apparatus and an electronic apparatus, and provides a sound-integrated display apparatus and an electronic apparatus comprising an excitation unit including a plurality of independently operating exciters, a displaying unit configured to visually display information and to generate sound by vibrating according to an operation of the exciters, and a confinement unit configured to confine vibrations generated in the displaying unit by the exciters.

### CROSS REFERENCE TO RELATED APPLICATIONS

This application claims priority from Republic of Korea Patent Applications No. 10-2025-0034651, filed on Mar. 18, 2025 and No. 10-2026-0040022, filed on Mar. 5, 2026, the contents of which are all hereby incorporated by reference herein in their entirety.

### TECHNICAL FIELD

The present invention relates to a sound-integrated display apparatus and an electronic apparatus, and more particularly, to a sound-integrated display apparatus and an electronic apparatus providing improved sound quality.

### BACKGROUND

The dominance of sight and hearing among human senses has driven advancements in display and audio technologies, and recently, there has been an increasing interest in multisensory integration for a more immersive experience. Therefore, beyond focusing on the visual quality of the display, research on displays that enhance user experience with features such as sound and tactile feedback is actively underway. So-called ‘multisensory displays’, which combine visual, sound, and tactile sensations, are effective in enhancing user engagement and realism.

To develop such multisensory displays, additional features such as sound and touch, along with the visual quality of the screen, are becoming increasingly important in enhancing the overall user experience and realizing a more immersive and realistic display. In short, there is a demand for a multisensory display that stimulates various human senses to complement visual information.

For this purpose, products integrating a display and a speaker, such as a display panel-integrated speaker, are being developed, but there are problems such as reduced practicality or degraded sound quality due to structural complexity.

### SUMMARY

The present invention is intended to provide a sound-integrated display apparatus and an electronic apparatus capable of solving the above-described problems, being structurally compact, and resolving the problem of sound quality degradation.

In particular, the present invention is intended to provide a sound-integrated display apparatus and an electronic apparatus capable of minimizing sound interference and improving frequency response.

To achieve the above object, the present invention provides a sound-integrated display apparatus comprising an excitation unit including a plurality of independently operating exciters, a displaying unit configured to visually display information and to generate sound by vibrating according to an operation of the exciters, and a confinement unit configured to confine vibrations generated in the displaying unit by the exciters.

Here, the confinement unit is provided to partition one side of the displaying unit, thereby confining a vibration generated in one partitioned region from being transmitted to another adjacent region. Specifically, the confinement unit is configured to form a plurality of divided regions, and the plurality of exciters are respectively disposed in the plurality of divided regions.

And, each of the exciters is disposed to be located at a center of each of the divided regions. A single exciter is disposed in a respective one of the divided regions.

Specifically, the confinement unit comprises a frame having a predetermined width and height, and the width of the frame may be at least 2 mm. Alternatively, the height of the frame may be at least 1 mm.

And, the confinement unit comprises a frame formed of a material having a predetermined Young's modulus, and the Young's modulus of the frame may be configured to have a value greater than a Young's modulus of the displaying unit.

The aforementioned divided region may have an area of at least twice a cross-sectional area of each of the exciters. Alternatively, the confinement unit comprises a frame forming a lattice, and a side of each lattice of the frame may have a length of at least 1.4 times a diameter of the exciter.

Here, the confinement unit is configured such that at least some of the plurality of divided regions form different areas, and the areas of the divided regions may be classified based on a frequency band generated by the exciters. As an example, among the plurality of divided regions, a region having a relatively large area is allocated to generate sound in a relatively low frequency band, and a region having a relatively small area may be allocated to generate sound in a relatively high frequency band.

In addition, it may further comprise a controller configured to control a directivity of the sound generated through the displaying unit by applying acoustic signals having independent time delays or phase differences to the plurality of exciters, respectively.

At this time, the controller may control a direction of the directivity to be varied in real time in conjunction with position information of a visual image displayed on the displaying unit, such that a focus of the sound tracks a position of the visual image.

Meanwhile, the aforementioned object of the present invention can also be achieved by an electronic apparatus comprising an excitation unit including a plurality of independently operating exciters, a displaying unit configured to visually display information and to generate sound by vibrating according to an operation of the exciters, and a confinement unit configured to confine vibrations generated in the displaying unit by the exciters.

According to the present invention, it is possible to improve sound quality by localizing the vibration generated by each exciter to minimize interference with vibrations from adjacent exciters.

In addition, the uniformity of the frequency response of the exciters can be improved through the optimal design of the frame forming the confinement unit.

Furthermore, by implementing a consistent and uniform frequency response, there is an advantage of simplifying the speaker response compensation process.

### BRIEF DESCRIPTION OF THE DRAWINGS

FIG. 1 is a plan view illustrating an electronic apparatus according to an embodiment.

FIG. 2 is a plan view illustrating an electronic apparatus according to another embodiment.

FIG. 3 is a perspective view illustrating main components of an electronic apparatus according to an embodiment of the present invention.

FIG. 4 is a diagram showing propagation characteristics of surface vibration according to sound generating devices having various structures.

FIG. 5 is a graph comparing frequency response characteristics of a plurality of exciters respectively depending on a presence or absence of a frame.

FIG. 6 is a graph comparing Total Harmonic Distortion (THD) characteristics of a plurality of exciters respectively depending on a presence or absence of a frame.

FIGS. 7 to 9(a) and 9(b) are diagrams showing vibration characteristics according to a variation in a width of a confinement unit.

FIGS. 10 to 12(a) and 12(b) are diagrams showing vibration characteristics according to a variation in a height of a confinement unit.

FIGS. 13 to 15(a) and 15(b) are diagrams showing vibration characteristics according to a stiffness of a confinement unit.

FIG. 16(a) and 16(b) are diagrams showing a surface vibration generated when driving multiple exciters depending on a presence or absence of a confinement unit.

FIG. 17 is a diagram showing a state in which an embodiment of the sound-integrated display apparatus according to the present invention is implemented using a commercial display panels.

### DETAILED DESCRIPTION

Hereinafter, with reference to the drawings, a sound-integrated display apparatus and an electronic apparatus according to embodiments of the present invention will be described in detail. In the following description, the positional relationship of each component is basically described with reference to the drawings. And, the drawings may simplify the structure of the invention for convenience of explanation or may be exaggerated if necessary. Therefore, the present invention is not limited thereto, and it goes without saying that the present invention can be implemented by adding, modifying, or omitting various devices.

Reference numerals are provided for convenience of explanation, and the same components may be described by assigning the same reference numerals. However, even if they are the same components, if they are shown in different drawings or are components of different embodiments, they may be described by assigning different reference numerals for convenience of explanation.

Even if the components in the drawings are partially modified and applied, if there is functional similarity and identity, they can be viewed as equivalent components. In addition, in light of the level of a person having ordinary skill in the art, if it is recognized as a component that should naturally be included, the description thereof may be omitted.

Meanwhile, in describing the present invention below, a sound display apparatus in which a sound generating function is integrated into a display apparatus as an example of an electronic apparatus is mainly described, but the present invention is not limited thereto. In addition to this, it is clarified that the present invention can be applied to various electronic apparatuses in which a function of displaying visual information and a function of generating sound are integrated.

The present invention relates to an electronic apparatus 1, which may be, for example, a sound-integrated display apparatus, or depending on the perspective, a display panel-integrated sound apparatus. The electronic apparatus 1 according to the present invention is configured to have a structure in which sound is generated by vibrating a display panel forming a displaying unit 10 using a plurality of piezoelectric elements as exciters.

Recently, in the display field, beyond visual quality, there is a demand to enhance immersion and provide a new user experience by adding functions such as sound or tactile feedback. To this end, in developing a sound-integrated display, applying an electrostatic speaker structure, a thermoacoustic speaker structure, and an electromagnetic speaker structure has been studied, but each has limitations in terms of structural complexity, power consumption, and sound quality.

In contrast, the method using piezoelectric elements like the present invention directly converts electrical energy into mechanical motion through an inverse piezoelectric effect, enabling efficient sound generation with a lightweight, flexible, and low-power design. And, a simple layered structure composed of electrodes and piezoelectric materials provides advantages such as low cost, high energy efficiency, and compactness. In addition, a material such as polyvinylidene fluoride (PVDF) enables flexible large-area speaker applications, making it highly suitable for integration with next-generation displays.

The electronic apparatus according to the present invention generates sound using a plurality of exciters. Compared to using a single exciter, this can improve performance as a speaker and implement stereo effects. On the other hand, when a plurality of exciters are used, complex vibrations occur in the display panel constituting a diaphragm. This complexity may cause sound quality degradation when different signals are applied to exciters sharing a single diaphragm, leading to interference between the vibrations. In addition, the arrangement of multiple exciters can lead to inconsistent frequency responses, complicating a compensation process. In general, speaker response compensation involves crossovers, filters, or digital signal processing (DSP), with demands increasing alongside the number of speaker channels, and in a panel speaker where each exciter has a different frequency response, the compensation process can be complicated.

Therefore, the present invention further comprises a confinement unit 20 separating regions between a plurality of exciters 31. The confinement unit 20 is a frame for isolating the vibration generated by each of the exciters, and can prevent mutual interference by confining and localizing the vibration of each of the exciters 31 to a target region.

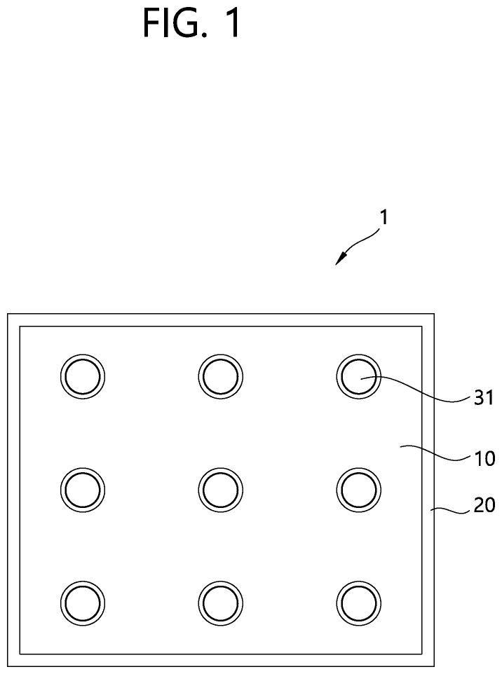

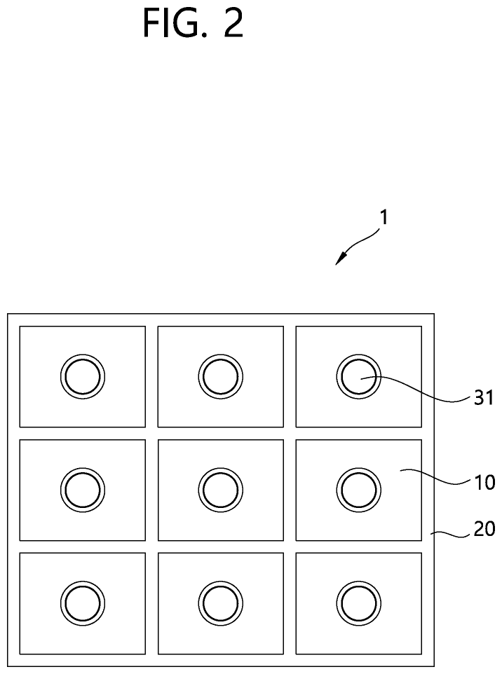

FIG. 1 is a plan view illustrating an electronic apparatus according to an embodiment, and FIG. 2 is a plan view illustrating an electronic apparatus according to another embodiment. FIGS. 1 and 2 illustrate a rear surface of the electronic apparatus, and a plurality of exciters 31 are disposed in a 3×3 matrix form on a rear surface of the display panel forming the displaying unit 10. And, the confinement unit 20 of the electronic apparatus 1 of FIG. 1 comprises a rectangular frame and is configured to support only an edge of the displaying unit, and the confinement unit 20 of the electronic apparatus of FIG. 2 comprises a frame forming a lattice structure and is configured to partition a region where each exciter is disposed.

In the case of the electronic apparatus of FIG. 1, the plurality of exciters 31 disposed on the same diaphragm (display panel) respectively generate vibrations, and the vibration generated by each exciter 31 propagates across the diaphragm to cause vibration interference with each other. In particular, this degrades sound quality in stereo systems. Also, the position of each exciter 31 significantly impacts a frequency response, resulting in variations in the frequency response across an exciter array.

In contrast, in the electronic apparatus 1 of FIG. 2, even though the plurality of exciters 31 are disposed on a single diaphragm, they are separately disposed in regions partitioned by the confinement unit 20. Therefore, the vibration by the exciter of FIG. 1 spreads throughout the diaphragm, but the vibration by the exciter of FIG. 2 is limited to a designated region. In this way, a localized vibration has an effect of attenuating vibration interference and distortion by each exciter 31. In addition, when each exciter 31 is disposed at a center of the partitioned region, it has a uniform frequency response as a whole.

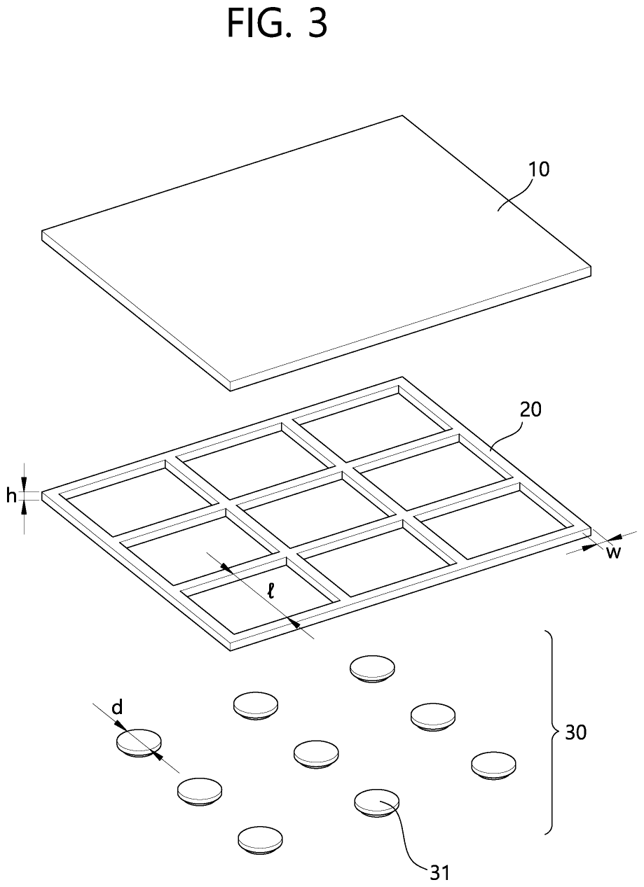

As discussed above, the sound-integrated display apparatus 1 having the plurality of exciters 31 is preferably configured to include the confinement unit 20 provided to partition the region where each exciter is disposed, as shown in FIG. 2. Hereinafter, the electronic apparatus according to an embodiment of the present invention will be described in more detail with reference to FIG. 3.

FIG. 3 is a perspective view illustrating main components of the electronic apparatus 1 according to an embodiment of the present invention. As shown in FIG. 3, the electronic apparatus according to the present embodiment includes a displaying unit, an excitation unit, and a confinement unit.

The displaying unit 10 is configured to display visual information to a user, and is composed of a flat panel-shaped display panel. A front surface of the display panel displays visual information to the user, and a plurality of exciters 31 are installed on a rear surface. The display panel is made of a flexible material and is configured to generate sound by vibrating according to the driving of the exciters disposed on the rear surface. The display panel may use an OLED panel as an example, and besides this, it is also possible to apply various display panels of a flexible structure capable of generating sound by vibrating.

The excitation unit 30 is a component for vibrating the displaying unit 10 to generate sound, and is composed of an exciter array including a plurality of exciters 31. Each of the exciters 31 is composed of a piezoelectric element as an example, but in addition to this, it may also be configured using various elements capable of generating sound by vibrating the displaying unit. Each exciter 31 is disposed to contact the displaying unit 10 on the rear surface of the displaying unit 10, and converts applied electrical energy into mechanical motion to vibrate the displaying unit 10. The excitation unit 30 according to the present embodiment is configured as an exciter array in which 9 exciters 31 are disposed in a 3×3 matrix form, but the present invention is not limited thereto and may be variously disposed in various numbers in consideration of the shape of the displaying unit or the designed acoustic characteristics.

The confinement unit 20 is a component for confining vibrations generated in the displaying unit 10 by the aforementioned exciters 31. Here, confining the vibration means confining the vibration from propagating outside the target region, and it may be confining spatially, confining the propagating vibration energy, or confining both. The confinement unit 20 of the present embodiment is composed of a frame installed in contact with the rear surface of the display panel. Such a frame is configured to partition the installed region into a plurality of divided regions, and the plurality of exciters 31 are configured to be respectively disposed in the plurality of divided regions. Such a frame is configured to partition the rear surface of the display panel constituting the displaying unit 10 into a plurality of regions, and confines a vibration by the exciter 31 disposed in one partitioned region from being transmitted to another adjacent region.

At this time, a front surface of the confinement unit is installed to contact the rear surface of the displaying unit, while at least a portion of a rear surface of the confinement unit may be configured to form an open end without contacting another member. If the rear surface of the confinement unit is also configured to be attached to a separate rear panel, the plurality of divided regions formed by the confinement unit will form a closed space by the displaying unit and the separate rear panel. In this case, the vibration generated in the displaying unit by the exciter may be reflected from the rear panel, thereby causing interference. Considering this, at least a portion of the rear surface of the confinement unit of the present embodiment forms an open end that does not contact another member, whereby the plurality of divided regions are partitioned from each other on the rear surface of the displaying unit but may be provided to be spatially in communication with each other. However, the present invention is not limited thereto, and the confinement unit may also be configured to be interposed between the displaying unit and the separate rear panel.

A single exciter 31 is disposed in a respective one of the regions partitioned by the confinement unit 20. And, each of the exciters 31 may be disposed at a center position of each partitioned region. Thereby, as described in FIG. 2, the vibration by each exciter is localized to minimize vibration interference and distortion caused by each other, thereby improving sound quality. In addition, by configuring to have a uniform frequency response as a whole, a speaker response compensation process requiring complex digital signal processing (DSP), crossovers, and filters adjustments can be simplified.

Specifically, the confinement unit 20 according to the present embodiment comprises a frame structure having a rectangular structure on the outside and partitioning an inner region into a plurality of divided regions by a lattice structure. The region partitioned by the frame structure may form a 3×3 matrix structure corresponding to the aforementioned exciter array. However, the present invention is not limited thereto, and the shape of the confinement unit may be variously modified and implemented according to the shape and size of the displaying unit, and the number and arrangement of the exciters.

Each frame is formed of a material having a predetermined Young's modulus, and may be composed of a member having a predetermined width and height. Each member has a rectangular cross-section, and the width of the frame may mean a width in contact with the display panel. In the present embodiment, the frame may be composed of a single integrally formed member. This is because, when the frame uses a structure in which a plurality of members are coupled, a vibration may be generated at a coupled portion during a vibration of the displaying unit, thereby causing a noise, and vibration attenuation characteristics may vary depending on a coupled state. In addition, among the frame of the present embodiment, remaining members excluding a member forming an outer edge (members disposed between the divided regions to partition the regions) may be formed to have the same width and height. This is to maintain constant vibration attenuation characteristics according to the shape of the frame.

However, the present invention is not limited thereto, and the frame forming the confinement unit may be composed of a plurality of individual members instead of a single frame, and it is also possible to form the confinement unit using members of various shapes other than a rectangular cross-section.

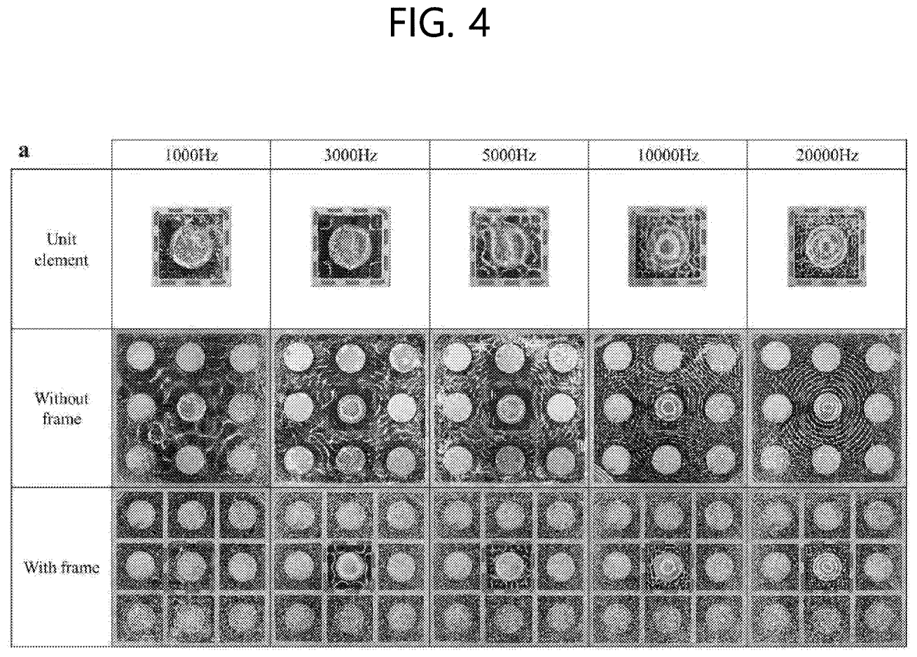

Hereinafter, characteristics of the electronic apparatus and a change in vibration characteristics according to the configuration of the confinement unit according to the present embodiment will be described in detail with reference to FIGS. 4 to 16.

FIG. 4 shows propagation characteristics of surface vibration according to sound generating devices having various structures. Here, the sound device is configured by using an exciter and a frame provided on a single diaphragm (corresponding to the displaying unit of the present invention). And, as for the propagation characteristics of the vibration, Chladni patterns visualizing the propagation aspect of the vibration occurring on the surface of the single diaphragm through fine particles such as sand when an acoustic signal is applied to a centrally located exciter can be confirmed.

Referring to FIG. 4, for various frequency (1000 Hz to 20000 Hz) bands, vibration aspects of a unit element model in which only a single exciter exists, a model without frame in which a 3×3 array of exciters are arranged and fixed only to an outer edge of a diaphragm (corresponding to the embodiment of FIG. 1), and a model with frame in which the region of each exciter is separated by a lattice-type frame (corresponding to the embodiment of FIGS. 2 and 3) are compared and shown respectively.

In the case of the model where the region is not divided by a frame (Without frame in FIG. 4), a phenomenon is observed in which the vibration generated from the central exciter escapes a target region and diffuses and propagates widely even to a peripheral region where adjacent exciters are disposed. As such, the vibration spreading throughout the diaphragm (displaying unit) causes vibration interference between adjacent exciters in a multi-exciter environment (e.g., a stereo system) where different signals are applied, resulting in distortion of sound and a degradation of overall sound quality.

On the other hand, in the case of the model in which regions are divided by a frame (With frame in FIG. 4), it can be confirmed that the vibration generated from the central exciter is effectively confined only within a designated area where the corresponding exciter is disposed, and propagation to an adjacent peripheral region is clearly blocked. That is, as the confinement unit 20 localizes the vibration of the surface of the displaying unit 10 (vibration localization) and physically isolates the vibration between exciters, a crosstalk-free vibration operation with minimized interference and distortion can be implemented even in a multi-exciter environment.

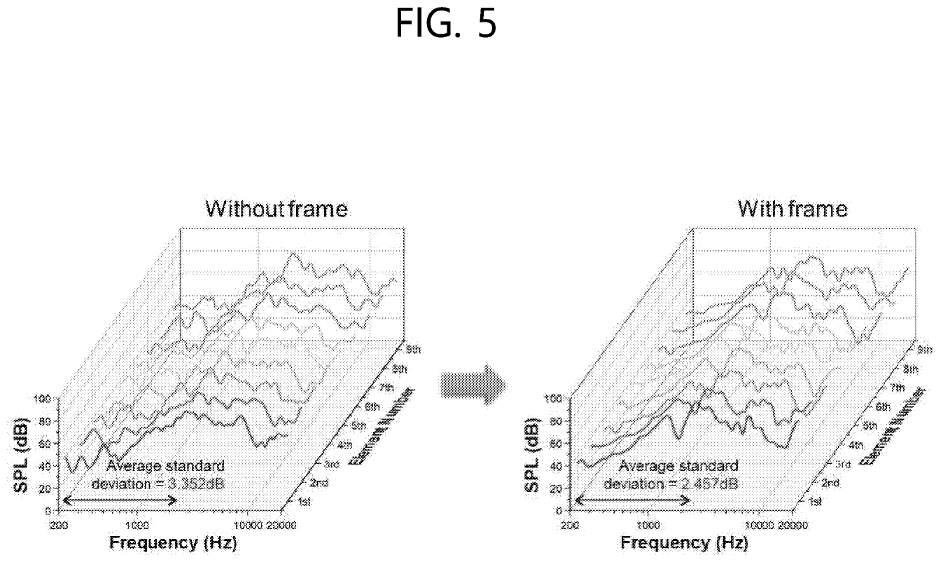

FIG. 5 is a graph comparing frequency response characteristics of a plurality of exciters respectively depending on a presence or absence of a frame.

For reference, this measurement for confirming the frequency response characteristics was performed inside an anechoic chamber of a predetermined size in order to exclude interference of external noise and precisely analyze sound. In the measurement process, a 10V peak-to-peak sine wave signal was generated using a waveform generator (e.g., PXIe-5413), and the signal was applied to each exciter disposed on the rear surface of the displaying unit in a manner of sweeping over a frequency band from 200 Hz to 20,000 Hz for 30 seconds. At this time, the sound output from the electronic apparatus was collected and measured using a microphone (e.g., B&K 4966) and a sound and vibration module (e.g., PXIe-4494), and overall control of signal generation and data collection was performed through signal processing software (e.g., LabVIEW).

Referring to FIG. 5, an on-axis frequency response according to a position (sequentially numbered from the top left) of each of 9 exciters 31 arranged in a 3×3 array on the rear surface of the diaphragm can be confirmed. In the case of the model where regions are not partitioned by a frame (Without frame in FIG. 5), it can be seen that frequency responses appear different from each other depending on the position of each exciter 31, resulting in a large deviation. On the other hand, in the model where regions of each exciter 31 are physically separated by a frame (With frame in FIG. 5), the 9 exciters show consistent frequency response characteristics with little deviation as a whole.

In generating sound, unless a specific frequency band is intentionally emphasized, consistent performance across multiple exciters is essential for implementing high-quality sound. Thus, the consistent frequency response characteristics achieved through the confinement unit (frame) 20 provide an effect of greatly simplifying a signal processing process utilizing crossovers, filters, and equalizers essentially required for frequency response compensation of an acoustic device.

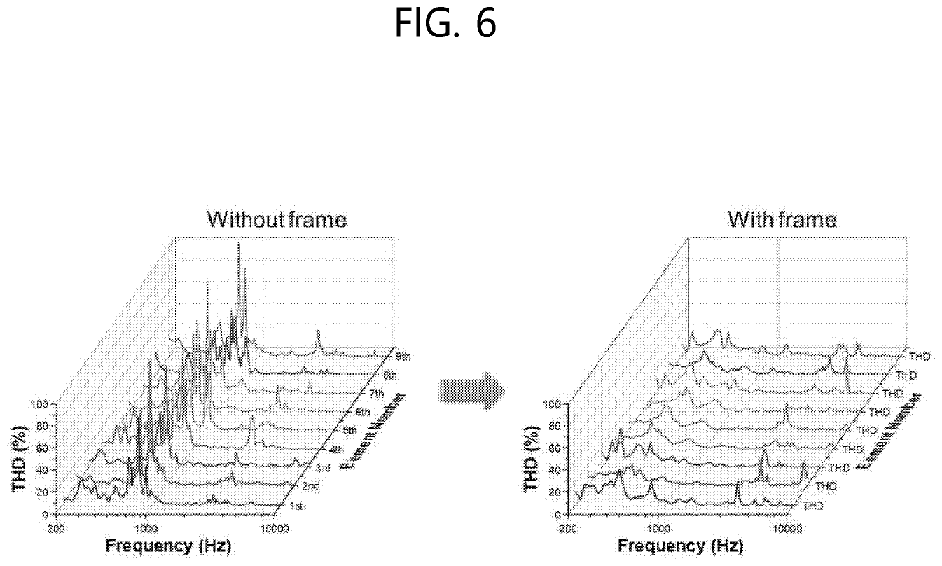

FIG. 6 is a graph comparing Total Harmonic Distortion (THD) characteristics of a plurality of exciters respectively depending on a presence or absence of a frame. For reference, this result is based on data acquired through the experimental environment described in FIG. 5, and is calculated by applying values of a first harmonic (fundamental frequency) to an n-th harmonic components to a calculation formula.

Referring to FIG. 6, in an exciter array sharing a single diaphragm (displaying unit), the total harmonic distortion (THD) of a case with a frame and a case without a frame is compared and shown for a position of an element to which a signal is applied. Total Harmonic Distortion (THD) is a main indicator representing accurate signal reproduction, and the lower this value is, the less sound distortion there is, meaning that clearer sound is output.

As shown in FIG. 6, in the case of the model where regions are not divided by a frame (Without frame in FIG. 6), it can be confirmed that a frequency band where the THD appears high varies randomly depending on a position of a driven exciter, and an overall THD value itself is also measured higher.

On the other hand, in the model where the region of each exciter is physically separated by a frame (With frame in FIG. 6) as in an embodiment of the present invention, the overall THD appears relatively significantly low, enabling clearer and more accurate signal reproduction. Furthermore, when the frame is provided, even if the position of the driven exciter changes, it shows a unique characteristic that the frequency bands where THD increases remain similar (aligned) to each other.

Like the frequency response described earlier in FIG. 5, the THD of the sound generating device can also be compensated through digital signal processing (DSP) and the like. Therefore, a structure of separating regions where exciters are disposed using a frame (with frame) not only simply reduces an overall THD value but also aligns frequency bands having high THD in a plurality of exciters into one, which ultimately has an advantage of greatly simplifying a signal processing process required for sound compensation of a multi-speaker system.

As described above in FIGS. 4 to 6, the confinement unit 20 dividing regions of the plurality of exciters 31 isolates a vibration generated by each exciter 31, thereby contributing to improving a quality of sound generated by the electronic apparatus 1. At this time, a vibration isolation effect by the confinement unit 20 appears differently depending on a material, shape, and dimensions of the frame constituting the confinement unit 20.

Specifically, an acoustic wave generated by driving the exciter 31 disposed in one region propagates along the displaying unit 10 and is partially absorbed and attenuated by the confinement unit, and then transmitted to an adjacent region. According to a wave equation, a degree of wave attenuation within the confinement unit is determined by a temporal absorption coefficient (β), which is an intrinsic property of a material. At this time, even if the confinement unit is configured with the same material, as dimensions (width, height, etc.) of the confinement unit increase, the absorption coefficient becomes higher, which can induce a stronger attenuation effect. In addition, since pressure of a wave has a characteristic of decreasing exponentially as a propagation distance within the confinement unit increases, consequently, a width and a height of the confinement unit affect localization performance of confining surface vibrations only within the region of each exciter. Therefore, hereinafter, a performance change according to a configuration of the frame will be described in detail based on experimental results.

First, in the electronic apparatus according to the present embodiment, it was confirmed that a vibration generated by an exciter propagates to an adjacent region, and at this time, attenuation of the vibration occurs differently depending on a width (w) of the frame along a propagation path.

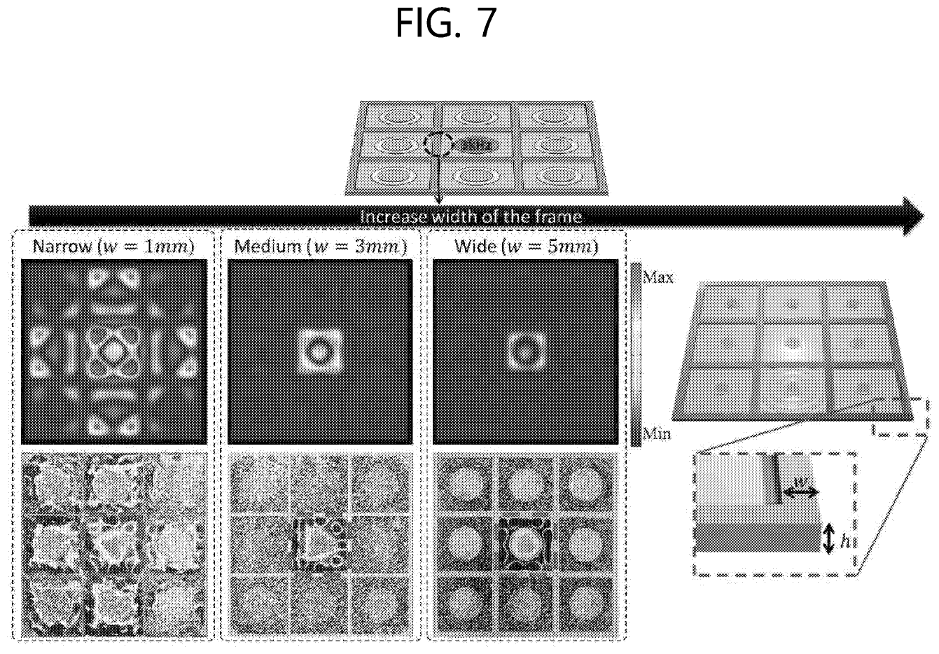

FIG. 7 compares a surface vibration localization effect according to a variation in width (w) of the confinement unit in FIG. 3. Specifically, when a signal of a specific frequency (for example, 3 kHz) is applied only to a centrally located exciter among the plurality of exciters 31 arranged in 3×3, a propagation aspect of surface vibration of a diaphragm to which the confinement units 20 having different widths are applied is visualized by a finite element method (FEM) and Chladni patterns using sand.

As an experimental result, in a narrow frame model where the width of the confinement unit 20 is 1 mm, attenuation of a wave was not sufficiently performed, so a phenomenon was observed in which a vibration generated from the central exciter diffused beyond the confinement unit into a peripheral region where other adjacent exciters are disposed. However, in a medium frame model where the width of the confinement unit 20 is 3 mm and a wide frame model where the width is 5 mm, a localization phenomenon is clearly confirmed in which the generated vibration does not propagate to another adjacent region and is effectively confined only within a designated region of the driven exciter.

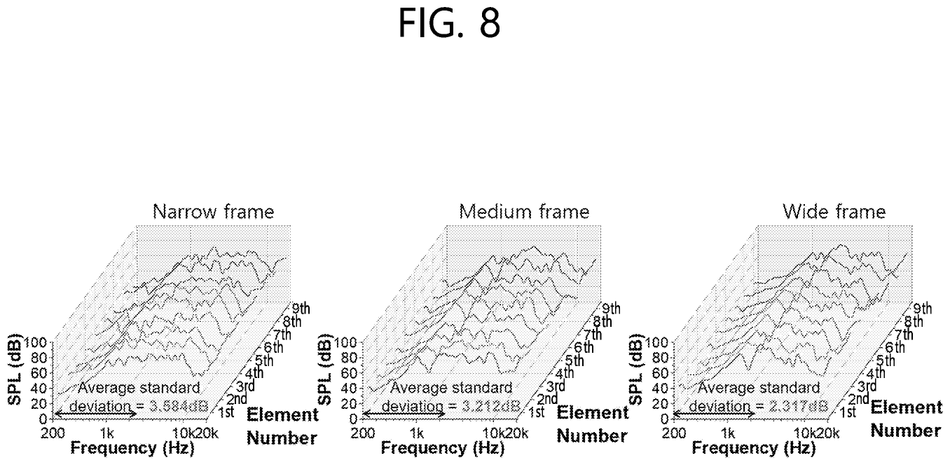

FIG. 8 is a diagram comparing frequency response characteristics of a plurality of exciters respectively according to a variation in width of a confinement unit according to an embodiment of the present invention.

Referring to FIG. 8, frequency responses for each exciter of a 3×3 array (9 in total) on the rear surface of the displaying unit 10 to which the confinement units 20 having different widths are applied as described in FIG. 7 are illustrated. Looking at experimental results, as a result of calculating a standard deviation of frequency response among 9 exciters within a 200 Hz to 2000 Hz frequency band where human hearing responds most sensitively, it was confirmed that a narrow frame model having a confinement unit width of 1 mm has an average standard deviation of 3.801 dB, a medium frame model having a width of 3 mm has an average standard deviation of 3.407 dB, and a wide frame model having a width of 5 mm has an average standard deviation of 2.457 dB.

This indicates that as a width of a frame member constituting the confinement unit 20 becomes wider, response deviations among each exciter within this important frequency range significantly decrease. Combined with the vibration localization result of FIG. 7 previously, it can be seen that as the width of the confinement unit increases beyond a predetermined width, performance of confining a surface vibration is greatly improved, and accordingly, even in a multi-exciter environment, individual exciters do not cause mutual interference and exhibit a uniform and consistent frequency response.

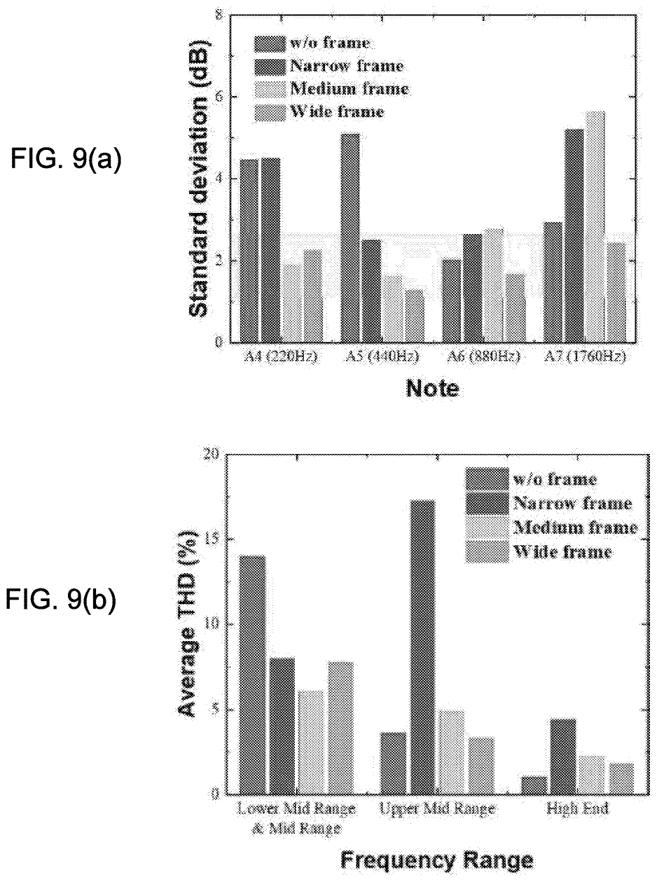

FIG. 9(a) and 9(b) are diagrams comparing Sound Pressure Level (SPL) deviations of specific musical notes generated from a plurality of exciters according to a variation in width of a confinement unit according to an embodiment of the present invention.

Referring to FIG. 9(a) and 9(b), results of measuring standard deviations of sound pressure levels among 9 exciters at A4 (220 Hz), A5 (440 Hz), A6 (880 Hz), and A7 (1760 Hz), which are frequencies corresponding to ‘A notes’ frequently utilized as a standard in audio engineering, can be confirmed. Along with the average deviation for the entire 200 Hz to 2000 Hz band described in FIG. 8, this drawing specifically shows how uniform performance a speaker system exhibits at specific frequencies (musical notes) where actual music is reproduced.

According to measurement results, in the case of a model without frame where the vibration of exciters is not physically isolated (localized) by a confinement unit, it can be seen that a standard deviation among 9 exciters appears relatively very high in a specific lower mid-range scale such as A4 and A5. This implies that interference among individual elements in a multi-exciter system can significantly degrade sound quality in a specific frequency band.

In addition, even if the confinement unit 20 is provided, it was confirmed that the wider a width (w) thereof is, the more consistently a lowest level of standard deviation is maintained across all musical note frequencies from A4 to A7 described above. This suggests that when the width of the confinement unit 20 is secured to a predetermined level or more, an ability to block vibration interference across an entire spectrum of a speaker is maximized without being concentrated in a specific frequency band.

Synthesizing the results shown in FIGS. 7 to 9(a) and 9(b) above, when the confinement unit 20 having an optimized wide width over a certain level is applied to the rear surface of the displaying unit to partition regions of a plurality of exciters 31, attenuation of a wave is maximized, and thus vibration localization performance is dramatically improved. Through this, it is possible to fundamentally block vibration interference occurring between adjacent elements in a multi-channel speaker system and implement precise localized sound control. Furthermore, by securing consistent frequency response characteristics by suppressing a response deviation for each frequency band across various exciters, a complex frequency response compensation process utilizing crossovers, filters, digital signal processing (DSP), etc. can be greatly simplified. Ultimately, the present invention provides superior sound quality that is uniform and free of distortion over the entire frequency range without being biased to a specific frequency band through such a configuration. This was confirmed to exhibit a positive effect as the width of the confinement unit becomes wider, and considering a main frequency range (for example, 200 Hz to 1500 Hz) to be generated in an electronic apparatus, it was confirmed to have improved sound quality when the width of the frame is at least 2 mm or more.

Meanwhile, not only the width (w) but also a height (h) of the frame constituting the confinement unit 20 has an important influence on an attenuation of waves and a vibration isolation effect. An acoustic wave generated by the exciter 31 of the displaying unit 10 is absorbed and attenuated by a confinement unit having a different stiffness during propagation, and is then transmitted to the displaying unit again or emitted into the air to generate sound. Therefore, as the height of the confinement unit increases, an attenuation effect of a wave is enhanced, which can induce stronger vibration confinement.

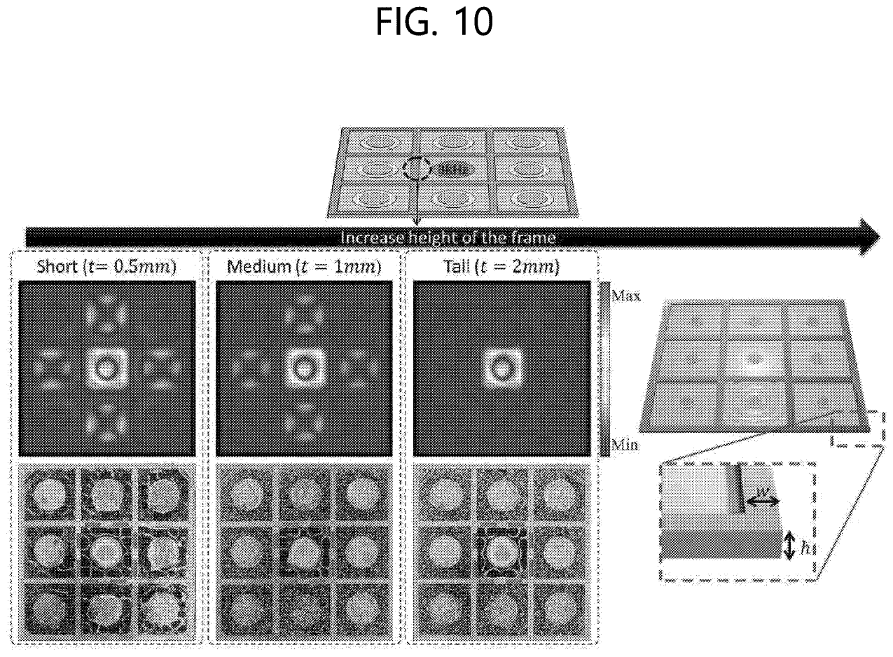

FIG. 10 is a diagram comparing and showing surface vibration localization effects according to a variation in height of a confinement unit according to an embodiment of the present invention. Referring to FIG. 10, when a signal of a specific frequency (for example, 3 kHz) is applied to a centrally located exciter 31 in a state where a width (w) is fixed to a constant 5 mm, results of visualizing a surface vibration aspect in cases of a short frame with a height of 0.5 mm (Short frame in FIG. 10), a medium frame with a height of 1 mm (Medium frame in FIG. 10), and a tall frame with a height of 2 mm (Tall frame in FIG. 10) by a finite element method (FEM) and Chladni patterns using sand can be confirmed. As an experimental result, as the height of the confinement unit 20 was lower, a phenomenon in which a vibration generated from the central exciter escapes a target region and diffuses and propagates into a peripheral region where other adjacent exciters 31 are disposed was clearly observed through a finite element method (FEM) simulation. On the other hand, as can be seen from the Chladni pattern results, when the height of the confinement unit reaches a certain level (for example, 1 mm) or more, a localization phenomenon is confirmed in which the vibration no longer spreads into an adjacent region and is effectively confined within the corresponding designated region.

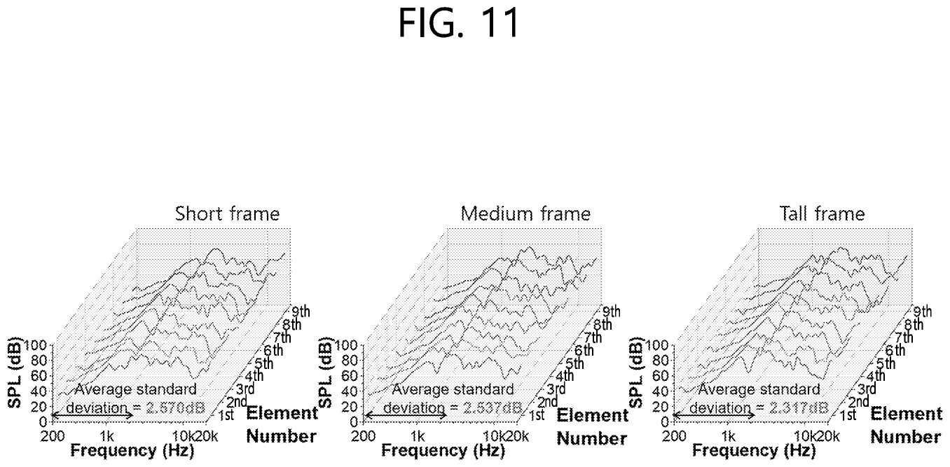

FIG. 11 is a diagram comparing frequency response characteristics of a plurality of exciters respectively according to a variation in height of a confinement unit according to an embodiment of the present invention. Referring to FIG. 11, an on-axis frequency response deviation of each exciter 31 according to a variation in height of the confinement unit 20 in an exciter array of 9 arranged in a 3×3 array can be confirmed. As a result of measuring an average standard deviation of frequency response among 9 exciters 31 within a 200 Hz to 2000 Hz frequency band where human hearing responds most sensitively, it was confirmed that a short frame model with a height of 0.5 mm has 2.736 dB, a medium frame model with a height of 1 mm has 2.691 dB, and a tall frame model with a height of 2 mm has 2.457 dB. This shows that as the height of the confinement unit 20 increases, frequency response deviations among each exciter significantly decrease to exhibit a more consistent response characteristic.

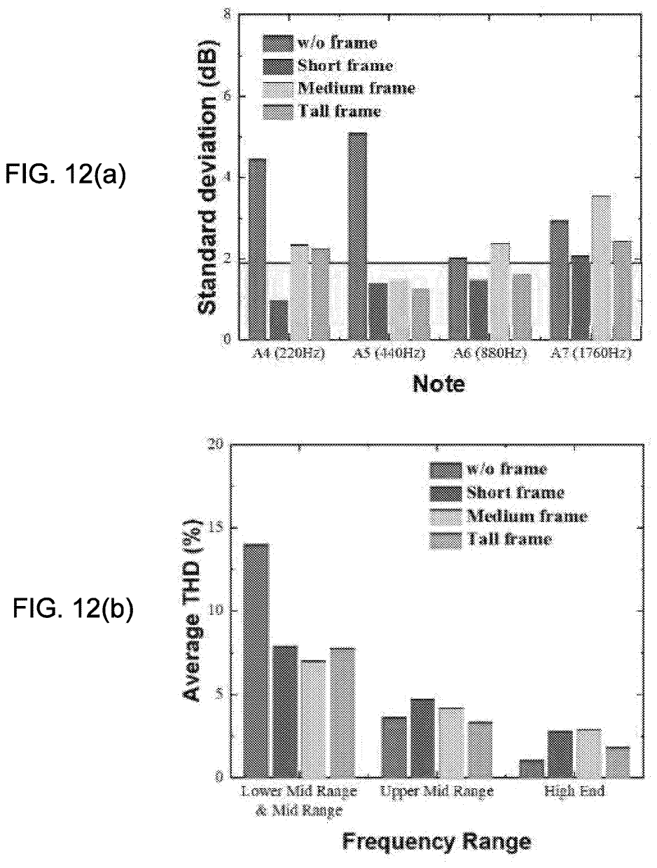

FIG. 12(a) and 12(b) are diagrams comparing Sound Pressure Level (SPL) deviations and average Total Harmonic Distortion (THD) characteristics of specific musical notes generated from a plurality of exciters according to a variation in height of a confinement unit according to an embodiment of the present invention. Referring to FIG. 12(a) and 12(b), results of measuring standard deviations of sound pressure levels among 9 exciters 31 at A notes (A4, A5, A6, A7) widely utilized as a standard in audio engineering can be confirmed. The model without frame where a vibration is not physically isolated (localized) by a confinement unit showed a relatively high level of standard deviation in specific frequency bands such as A4 and A5. On the other hand, although models equipped with the confinement unit 20 localizing a vibration did not show a clear linear tendency of deviation according to an increase in frame height across all frequencies, it was confirmed that they maintained a consistently low standard deviation overall regardless of each driving position compared to a case without the confinement unit 20. Also, looking at the average Total Harmonic Distortion (THD) measurement results, all models to which the confinement unit was applied showed a result that THD noticeably decreases in lower mid-range and mid-range frequencies where hearing responds sensitively, compared to the model without the confinement unit.

Consequently, synthesizing the experimental results of FIGS. 10 to 12(a) and 12(b), it can be seen that the confinement unit 20 having a constant width exerts a powerful vibration localization performance by more effectively absorbing and attenuating vibrations when its height is secured to be at least 1 mm or more. By applying the confinement unit 20 having an optimized height to the rear surface of the displaying unit 10 in this way, it is possible to fundamentally block vibration interference occurring between adjacent elements in a multi-exciter environment and significantly reduce a frequency response deviation between each exciter 31. This ensures a consistent frequency response performance across a multi-channel speaker system, thereby not only greatly simplifying a complex signal compensation process, but also remarkably suppressing sound distortion (THD) in a sensitive lower mid-range to further improve overall sound quality.

Furthermore, not only a shape (width and height) of the confinement unit 20 reviewed above, but also a mechanical stiffness, specifically a Young's modulus, of a material constituting the confinement unit 20 has a significant impact on surface vibration propagation and isolation effects. If the Young's modulus of the frame constituting the confinement unit 20 is lower than the Young's modulus of a display panel constituting the displaying unit 10 serving as a diaphragm, the confinement unit 20 vibrates together with the displaying unit 10 to induce distortion, and conversely, when it has a higher Young's modulus than the displaying unit, it can localize a vibration more effectively.

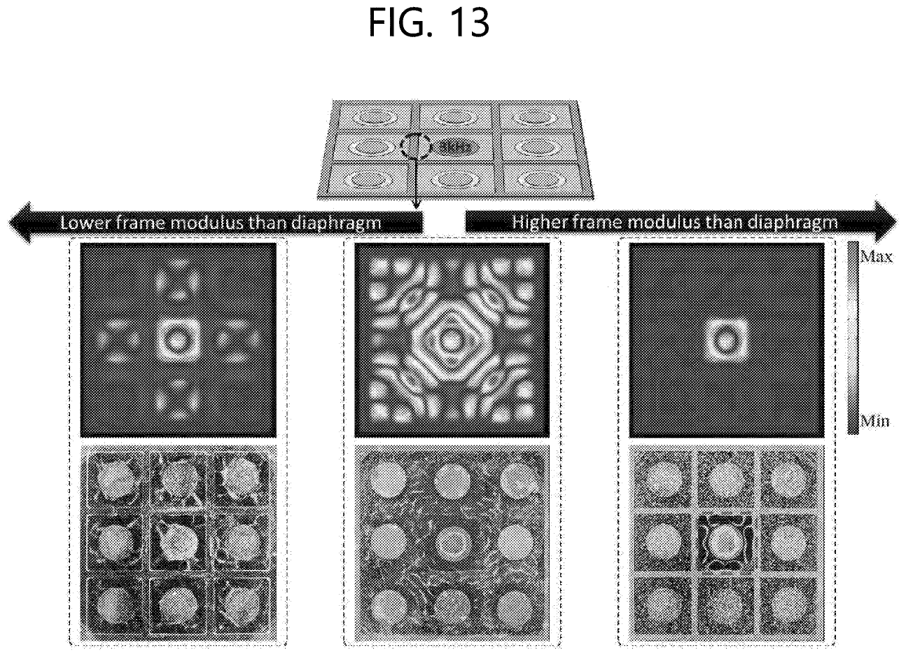

FIG. 13 is a diagram comparing and showing surface vibration localization effects according to a Young's modulus difference between a confinement unit and a displaying unit according to an embodiment of the present invention. Referring to FIG. 13, results of visualizing a surface vibration aspect occurring when a signal of a specific frequency (for example, 3 kHz) is applied to a centrally located exciter 31 through Chladni patterns and a finite element method (FEM) simulation can be confirmed. In this experiment, based on a material (for example, a PET film with a Young's modulus of 1.9 GPa) constituting the displaying unit (diaphragm) 10, a model applying a confinement unit having a lower Young's modulus (Lower frame modulus—left result of FIG. 13, for example, polycarbonate (PC) with a Young's modulus of 1.1 GPa), a model applying a confinement unit having the same Young's modulus (center result of FIG. 13), and a model applying a confinement unit having a higher Young's modulus (Higher frame modulus—right result of FIG. 13, for example, stainless steel (SUS) with a Young's modulus of 193 GPa) were compared. As an experimental result, in a model to which the confinement unit 20 having a lower Young's modulus than the displaying unit 10 is applied, vibration localization was somewhat improved compared to a case without any confinement unit, but a phenomenon was still observed in which a considerable amount of vibration generated in the central exciter 31 was transmitted (propagated) beyond the confinement unit 20 to an adjacent exciter region. On the other hand, in an embodiment of the present invention to which the confinement unit 20 having a Young's modulus equal to or higher than the displaying unit 10 is applied, an excellent vibration localization performance of effectively blocking vibration propagation to an adjacent region by much more firmly confining a generated vibration within a target region was shown.

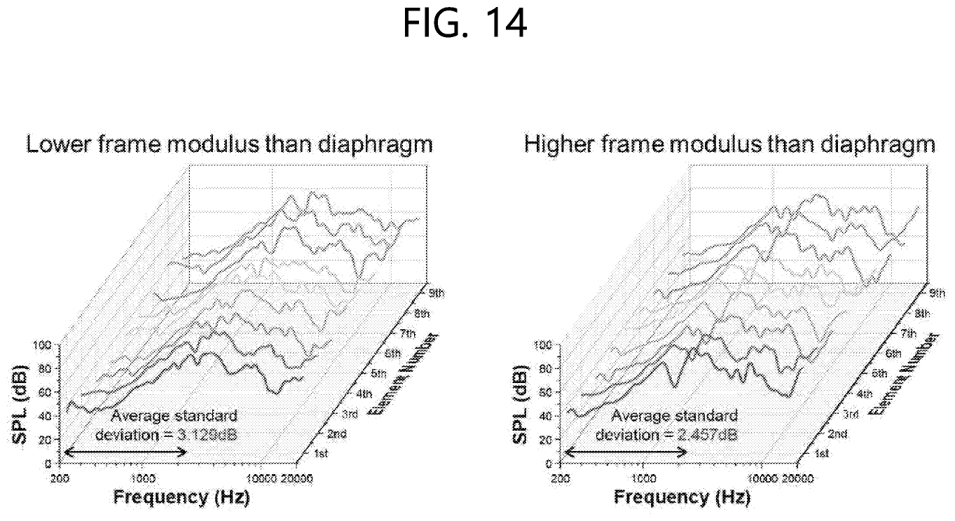

FIG. 14 is a diagram comparing frequency response characteristics of a plurality of exciters respectively according to a Young's modulus difference between a confinement unit and a displaying unit according to an embodiment of the present invention. Referring to FIG. 14, an on-axis frequency response deviation of each of 9 exciters 31 arranged in a 3×3 array with respect to a low modulus frame applied model and a high modulus frame applied model described in FIG. 13 above can be confirmed. As a measurement result, a model to which the confinement unit 20 with a low Young's modulus was applied showed a relatively high average standard deviation among 9 exciters of 3.129 dB within a 200 Hz to 2000 Hz frequency band where human hearing responds most sensitively. On the other hand, in a model of the present invention to which the confinement unit 20 having a higher Young's modulus than the displaying unit 10 is applied, an average standard deviation is measured to be significantly low at 2.457 dB within the same band, so it can be seen that frequency response deviations between each exciter are very small and a consistent response characteristic is exhibited. This implies that when a material of the confinement unit 20 has sufficiently higher stiffness than a diaphragm, uniform frequency response characteristics advantageous for signal compensation across an entire multi-exciter system can be secured.

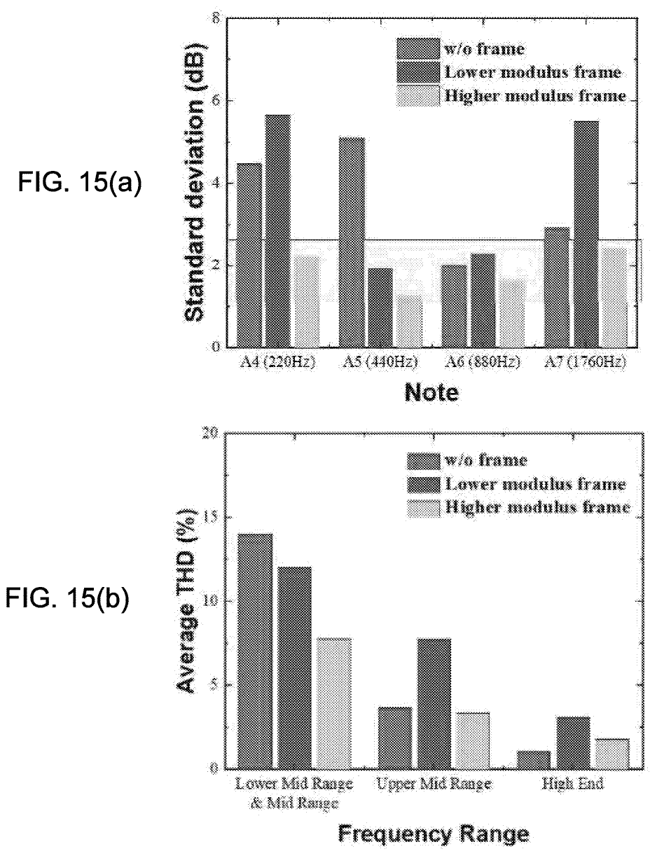

FIG. 15(a) and 15(b) are diagrams comparing Sound Pressure Level (SPL) deviations of specific musical notes generated from a plurality of exciters according to a Young's modulus difference between a confinement unit and a displaying unit according to an embodiment of the present invention. Referring to FIG. 15(a) and 15(b), results of measuring standard deviations of sound pressure levels among 9 exciters in an A notes band (A4 to A7) widely utilized as a standard in audio engineering can be confirmed. When a confinement unit having a lower Young's modulus than the displaying unit 10 (Lower modulus frame) is applied, performance among multiple exciters appeared non-uniform, still showing a high level of deviation in specific musical notes (for example, A4 and A7 bands). However, in an embodiment of the present invention to which a confinement unit having a higher Young's modulus than the displaying unit 10 (Higher modulus frame) is applied, it was confirmed that a lowest level of deviation was consistently maintained across all musical note frequency bands from A4 to A7 described above.

Consequently, synthesizing the experimental results of FIGS. 13 to 15(a) and 15(b), it can be seen that in designing the confinement unit 20 of a sound display apparatus, configuring a confinement unit (frame) with a material having a higher Young's modulus (stiffness) than the displaying unit 10 serving as a diaphragm contributes to an improvement in acoustic performance. As an experimental result, when a material of the frame has a Young's modulus in a range of 2 to 200 times a Young's modulus of a material of a panel forming the displaying unit, the aforementioned advantageous effects can be achieved. More specifically, when the material of the frame has a Young's modulus in a range of 5 to 100 times the Young's modulus of the material of the panel forming the displaying unit, the aforementioned advantageous effects can be achieved. In addition, when configuring a sound-integrated display apparatus using a flexible display panel, if the confinement unit is configured using a material having a Young's modulus in a range of 1.5 to 10 times a Young's modulus of a material of a panel of the displaying unit, an effective vibration attenuation and an acoustic performance improvement can be exhibited.

As such, when the confinement unit 20 having a higher stiffness than the displaying unit 10 is applied, vibration localization performance can be maximized by strongly blocking vibration energy of individual exciters from leaking to an adjacent region. Furthermore, this maximized vibration isolation effect minimizes deviations and derives a consistent frequency response regardless of a driving position or a specific frequency (musical note) band in a multi-exciter environment. As a result, this greatly simplifies a sound compensation process through crossovers or digital signal processing (DSP), and exerts a remarkable effect of providing superior sound quality that is clear and suppressed in distortion across an entire frequency range of a system.

Comprehensively, when comparing an effect of changes in dimensions (width, height) and material (Young's modulus) of a confinement unit (frame) coupled to the displaying unit 10 on acoustic response characteristics, it was confirmed that increasing a width and a height of the confinement unit 20 and simultaneously using a material having higher stiffness than a diaphragm is a factor in securing a consistency of frequency responses across the multiple exciters 31 and improving efficiency of response compensation. In particular, considering characteristics in a main frequency band to be generated in the electronic apparatus 1, it was found to be desirable that the width of the confinement unit is 2 mm or more, the height is 1 mm or more, and a material of the confinement unit 20 is used as a stiff material having a higher Young's modulus than a material of the displaying unit.

Furthermore, results of evaluating operational reliability of an electronic apparatus (sound display apparatus) having regions partitioned by a confinement unit according to embodiments of the present invention are as follows. As a result of evaluating time stability according to continuous driving to check performance degradation due to mechanical or electrical factors (stress, temperature change, etc.), when re-measured after continuous driving for 10 minutes after initial frequency response measurement, it was confirmed to maintain almost constant response characteristics within an error range, so it can be seen that performance is stable even when driven for a long time. Also, regarding sound pressure output characteristics, it was confirmed that a sound pressure increases linearly in proportion to a magnitude of an applied voltage (peak-to-peak voltage) to provide a stable and linear output meeting basic acoustic principles. In addition, as a result of measuring a change in sound pressure according to a distance from a center of a speaker, a sound pressure decreased consistently as a distance increased, and specifically, a characteristic of a sound pressure halving when a distance increased twofold was exhibited.

Consequently, the sound-integrated display apparatus to which a confinement unit structure according to the present invention is applied can stably provide predictable and highly reliable speaker operation performance over a long period of time in terms of temporal, electrical, and spatial aspects, as well as an effect of vibration isolation and sound quality improvement.

Meanwhile, in a stereo system in which a plurality of exciters are arranged on a displaying unit composed of a single panel, when different sound signals are applied to different exciters, mutual interference occurs among vibrations generated from each exciter, which can degrade overall sound quality.

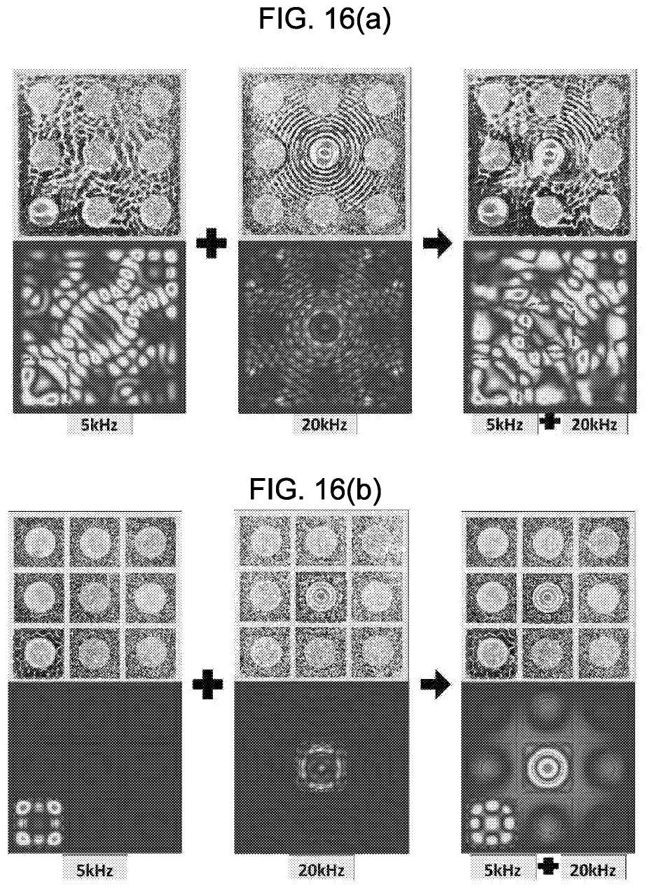

FIG. 16(a) and 16(b) are diagrams comparing and showing surface vibration interference and isolation effects generated when driving multiple exciters, depending on a presence or absence of a confinement unit according to an embodiment of the present invention. FIG. 16(a) illustrates a vibration aspect in a model without a confinement unit (or a model where only an outer edge of a displaying unit is supported), FIG. 16(b) illustrates a vibration aspect in a model according to an embodiment of the present invention in which regions of each exciter are physically divided by a confinement unit.

Referring to FIG. 16(a) and 16(b), results of visualizing a vibration propagation aspect occurring on a surface of a displaying unit when a signal of 5 kHz is applied to an exciter located at a bottom left and a signal of 20 kHz is applied simultaneously to a centrally located exciter by Chladni patterns using sand and a finite element method (FEM) simulation can be confirmed.

As an experimental result, as shown in FIG. 16(a), in a model without region division by a confinement unit (Without frame separation), it was confirmed that a vibration pattern by a 5 kHz signal and a vibration pattern by a 20 kHz signal appeared overlapping each other out of corresponding regions. This indicates that a severe vibration interference occurs among adjacent exciters 31, so that each signal is not fully and independently reproduced.

On the other hand, as shown in FIG. 16(b), in a structure in which regions of each exciter 31 are partitioned by a confinement unit 20 (With frame separation), it can be confirmed that respective vibration patterns generated by 5 kHz and 20 kHz signals clearly appear isolated only within respective designated regions. That is, an excellent result is shown in which a phenomenon where a vibration wave generated in one region is transmitted to another region or mixed with each other is effectively separated and blocked (effective vibration separation).

In conclusion, a sound-integrated display apparatus (or an electronic apparatus) according to various embodiments of the present invention prevents a vibration interference (crosstalk) on a surface of a diaphragm and drastically improves frequency response characteristics through localized control of multi-arrayed exciters, thereby providing a precise localized sound output perfectly synchronized with a visual image.

In particular, by introducing a confinement unit (frame) structure for vibration isolation whose shape (width and height) and material (Young's modulus) are optimized, the present invention has successfully implemented crosstalk-free sound emission that is independently controllable for each exciter even in a single diaphragm-based panel-type piezoelectric speaker environment. The confinement unit effectively confines a surface vibration within a designated region to fundamentally block propagation to an adjacent region, and has an effect of greatly simplifying a complex response compensation process by reducing a standard deviation by increasing a uniformity of frequency response among each exciter.

In particular, when the width and the height of the confinement unit are secured to a certain level or more, and the confinement unit is formed of a material having a higher modulus than a material of the diaphragm (displaying unit), vibration localization performance is maximized to remarkably reduce Total Harmonic Distortion (THD) over a wider frequency band, and consequently, a much clearer and more accurate high-quality sound can be reproduced.

However, when the width of the confinement unit is excessively extended, an area where the displaying unit vibrates by an exciter to generate sound may be excessively reduced. Therefore, in designing the confinement unit, a short side length (l in FIG. 3) of a divided region (a vibratable region excluding the frame) partitioned by the frame can be configured to be at least 1.4 times or more of a diameter (d) of the exciter. Alternatively, a divided region partitioned by the frame can be configured to be twice or more of a cross-sectional area of an exciter.

A frame of the above-described embodiment is configured to form a rectangular-shaped divided region, but the present invention is not limited thereto. Depending on a shape or acoustic design of a displaying unit, it may also be configured to form a square divided region or a circular, regular hexagonal, etc. divided region.

In addition, the frames of the above-described embodiments are all configured to form divided regions of the same size, but the present invention is not limited thereto. As an example, when outputs of exciters are different, a divided region where an exciter with a large output is disposed may be formed relatively wide, and a divided region where an exciter with a small output is disposed may be formed relatively narrow. As another example, even when outputs of exciters are the same, a divided region disposed at an edge of a displaying unit may be formed to be relatively smaller or relatively larger than a divided region disposed inside a displaying unit. In this way, a size of a divided region can be variously implemented according to an output of an exciter and acoustic characteristics to be designed. Or as another example, based on a frequency band of a vibration generated by an exciter, areas of divided regions can be configured differently. For example, among a plurality of divided regions, a region having a relatively large area may be allocated to generate a sound of a low frequency band corresponding to a relatively low-frequency band. And, a region having a relatively small area may be allocated to generate a sound of a high frequency band corresponding to a relatively high-frequency band.

Also, a frame of the above-described embodiment is formed in a structure having the same width and height, but the present invention is not limited thereto. This also can be configured such that a width or a thickness is different for each position according to a shape or acoustic design of a displaying unit. As an example, a portion of the frame relatively adjacent to an exciter may be formed to have a relatively wide width and a high height, and a portion relatively spaced apart from an exciter may be formed to have a relatively narrow width and a low height.

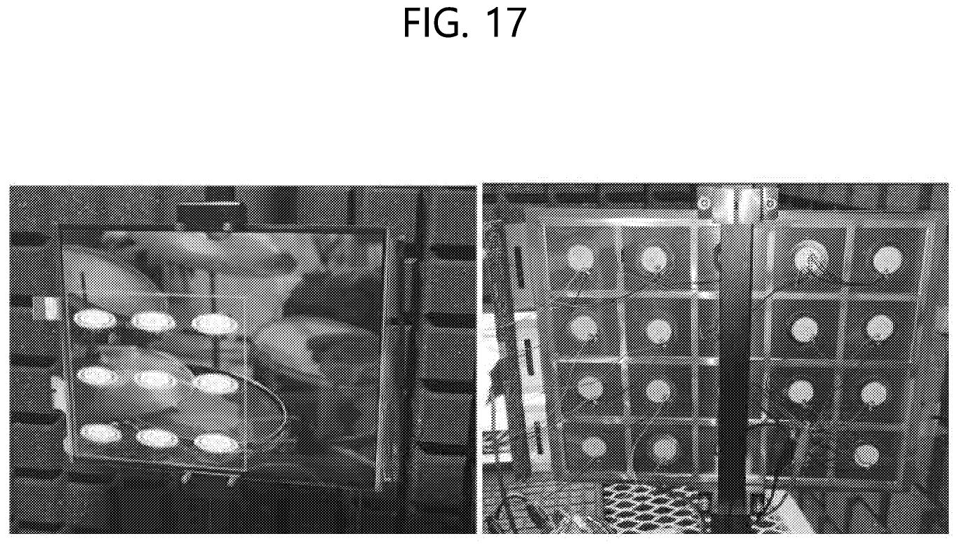

FIG. 17 is a view illustrating a state in which a sound-integrated display apparatus according to an embodiment of the present invention is applied to a commercial display panel.

Referring to FIG. 17, a state in which a speaker module to which a plurality of piezoelectric exciters and a confinement unit for vibration isolation are attached is coupled to a rear surface of a commercial display panel (for example, a 13-inch OLED panel) to actually play audio can be confirmed. In the case of FIG. 17, as previously confirmed in FIG. 16(a) and 16(b), a driving region of each exciter is physically perfectly isolated (crosstalk-free) by a confinement unit to induce independent localized surface vibrations. This enables precise localized acoustic control perfectly synchronized with a visual image on a display. In particular, even if vibrations of a display panel due to driving of a speaker occurred, no degradation or deterioration in visual image quality of a display was observed at all, and it was experimentally proved that high-quality sound can be simultaneously provided while maintaining a clear image quality at the same level as a standalone OLED display.

Furthermore, a ‘Sound Pixel independent array’ structure in which vibrations are perfectly localized through a confinement unit in this way provides an optimized hardware basis for implementing a Sound Beamforming and a Directivity Control, which are next-generation acoustic technologies.

In a conventional single diaphragm-based panel speaker, due to vibration interference (Crosstalk) generated as a vibration propagates to an entire plate, independent phase control of each exciter is practically impossible, thus there was a fatal hardware limitation in applying a Sound Beamforming technology. However, the present invention physically isolates (Physical Isolation) vibration energy by confining it within a specific partition through a lattice-shaped frame (confinement unit), thereby functioning each exciter as a perfectly independent Point Source.

Accordingly, an electronic apparatus (sound display apparatus) according to embodiments of the present invention may further comprise a controller (not shown) configured to control a directivity of sound. The controller may apply a signal in which an independent Time Delay or a Phase is controlled to the plurality of exciters, respectively. Since each region is physically separated, even if different phase and amplitude signals are applied to a plurality of exciters, a distortion due to interference does not occur, and through this, precise Phased Array control can be performed to perfectly induce constructive interference and destructive interference of sound waves in a specific space.

In addition, uniform frequency response and low THD characteristics between each exciter derived through numerical optimization of a confinement unit (for example, applying a width of 2 mm or more, a height of 1 mm or more, a higher Young's modulus than a displaying unit, etc.) form a ‘Predictable Sound Field’ that makes an actual radiated sound field coincide with a physical wave result predicted by a beamforming algorithm. The reliability and efficiency of a beamforming system are maximized because high-quality independent acoustic signals in a Crosstalk-free state are already secured at a stage before software (DSP) compensation.

Based on such precise directivity control, the controller may perform an Adaptive Beam forming that focuses a Focus of sound to a specific position (e.g., a position of a user) or moves it in real time. Furthermore, in conjunction with position information (coordinates) of a visual image (object) displayed on a screen of a displaying unit, it may be controlled such that a focus of a sound beam tracks a visual image and is varied in real time, centered on exciters corresponding to coordinates where the object is located.

As a result, unlike conventional methods relying only on software compensation, the present invention fundamentally solves an interference problem through a physical structure called a ‘confinement unit’, thereby not only providing an immersive multisensory display experience maximizing Audio-Visual Synchronization to a user but also having a remarkable effect of greatly improving expandability into a large-area panel speaker array.

In addition, as shown in FIG. 17, the sound-integrated display apparatus according to the present embodiment can implement a sound-integrated display device having a thin structure by using a piezoelectric element as an exciter and using a confinement unit having optimized material characteristics and shape. Specifically, a thickness of the exciter can be configured to be 5 mm or less, and the sound-integrated display apparatus including such an exciter and the aforementioned confinement unit can be implemented to have a thickness of 10 mm or less.

As described above, as a result of long-term reliability evaluation on a display apparatus to which a localized acoustic control structure according to the present invention is applied (for example, a 13-inch OLED panel used in this experiment), it was confirmed that it maintained performance as a highly stable and reliable sound generating device even after a long period of operation by showing a consistent and predictable change in sound pressure level (SPL) according to an input voltage and a distance. These technical features of the present invention provide a remarkable effect of essentially improving an acoustic quality and a durability of a thin and flexible sound-integrated display apparatus, and furthermore, they can be utilized as a basic technology for commercialization and expansion of application fields of next-generation multisensory audio-visual display systems including OLED, which essentially require high-quality sound integration.

In the above, one embodiment of the present disclosure has been described in detail, but aspects of the present disclosure are not limited to the above embodiment. It will be understood by those of ordinary skill in the art that various modifications and changes may be made therein through inclusion, alteration, removal or addition of elements without departing from the spirit and scope of the present disclosure as defined by the following claims.

What is claimed is:

1. A sound-integrated display apparatus comprising:
an excitation unit including a plurality of exciters configured to operate independently;
a displaying unit configured to visually display information and to generate sound by vibrating in response to an operation of the exciters; and
a confinement unit configured to confine vibrations generated in the displaying unit by the exciters.

2. The sound-integrated display apparatus of claim 1, wherein the confinement unit is provided to partition one side of the displaying unit, thereby confining a vibration generated in one partitioned region from being transmitted to another adjacent region.

3. The sound-integrated display apparatus of claim 1, wherein the confinement unit is configured to form a plurality of divided regions, and the plurality of exciters are respectively disposed in the plurality of divided regions.

4. The sound-integrated display apparatus of claim 3, wherein each of the exciters is disposed to be located at a center of each of the divided regions.

5. The sound-integrated display apparatus of claim 3, wherein each of the exciters is singularly disposed in a respective one of the divided regions.

6. The sound-integrated display apparatus of claim 1, wherein the confinement unit comprises a frame having a predetermined width and height, and the width of the frame is at least 2 mm.

7. The sound-integrated display apparatus of claim 1, wherein the confinement unit comprises a frame having a predetermined width and height, and the height of the frame is at least 1 mm.

8. The sound-integrated display apparatus of claim 1, wherein the confinement unit comprises a frame formed of a material having a predetermined Young's modulus, and the Young's modulus of the frame has a value greater than a Young's modulus of the displaying unit.

9. The sound-integrated display apparatus of claim 3, wherein the divided region has an area of at least twice a cross-sectional area of each of the exciters.

10. The sound-integrated display apparatus of claim 3, wherein the confinement unit comprises a frame forming a lattice, and a side of each lattice of the frame has a length of at least 1.4 times a diameter of the exciter.

11. The sound-integrated display apparatus of claim 1, wherein the confinement unit is configured such that at least some of the plurality of divided regions form different areas, and the areas of the divided regions are classified based on a frequency band generated by the exciters.

12. The sound-integrated display apparatus of claim 11, wherein, among the plurality of divided regions, a region having a relatively large area is provided to generate sound in a relatively low frequency band, and a region having a relatively small area is provided to generate sound in a relatively high frequency band.

13. The sound-integrated display apparatus of claim 1, further comprising: a controller configured to control a directivity of the sound generated through the displaying unit by applying acoustic signals having independent time delays or phase differences to the plurality of exciters, respectively.

14. The sound-integrated display apparatus of claim 13, wherein the controller is configured to control a direction of the directivity to be varied in real time in conjunction with position information of a visual image displayed on the displaying unit, such that a focus of the sound tracks a position of the visual image.

15. The sound-integrated display apparatus of claim 1, wherein each of the exciters has a thickness of 5 mm or less, and the sound-integrated display apparatus is configured to have a thickness of 10 mm or less.

16. An electronic apparatus comprising: an excitation unit including a plurality of independently operating exciters; a displaying unit configured to visually display information and to generate sound by vibrating according to an operation of the exciters; and a confinement unit configured to confine vibrations generated in the displaying unit by the exciters.
